(19) United States
(12) Patent Application Publication
(10) Pub. No.: US 2021/0395443 A1
(43) Pub. Date: Dec. 23, 2021

(54) Integrated Preparation Process for Producing Polyglycolic Acid Products

(71) Applicant: Pujing Chemical Industry Co., Ltd., Shanghai (CN)

(72) Inventor: Saibo WANG, Shanghai (CN)

(21) Appl. No.: 17/289,445

(22) PCT Filed: Oct. 29, 2018
(86) PCT No.: PCT/CN2018/112470

§ 371 Date: Apr. 28, 2021

(51) Int. Cl. C08G 63/06; B29B 9/12; B29B 9/06; B29B 9/10; C08G 63/83; C08G 63/78

(52) U.S. Cl. CPC C08G 63/06; B29B 9/12; B29B 9/065; B29K 2067/043; C08G 63/83; C08G 63/785; B29B 9/10

(57) ABSTRACT

The invention relates to an integrated process for producing a polyglycolic acid product, including polymerization, modification and molding. The resulting polyglycolic acid product may maintain the physical and chemical properties of polyglycolic acid to the greatest extent, including yellowness index (YI), weight-average molecular weight, strength and mean square radius of rotation. Also provided are the polyglycolic acid product and apparatus for carrying out the integrated process.

### FIELD OF THE INVENTION

The invention relates to polyglycolic acid product production.

### BACKGROUND OF THE INVENTION

Polyglycolic acid is the simplest structural aliphatic polyester. It was also the first bioactive absorbable suture material. It has many applications in the medical field, such as drug controlled release systems and solid stents for plastic surgery. Polyglycolic acid has excellent processing properties, high mechanical strength and modulus, high solvent resistance, good biocompatibility, high gas barrier properties and biodegradability. Based on these properties, polyglycolic acid can be used in packaging materials and agricultural biodegradable films in addition to medical materials.

The industrial preparation of polyglycolic acid is difficult. Polymers having high molecular weight obtained in a single reactor cannot be pulled into strips successfully because of their melting viscosity. The different residence time of the materials in the reaction kettle results in significantly different product properties (e.g., yellowness index, weight-average molecular weight and inherent viscosity) before and after the reaction. A twin screw has been used to obtain a solid pulverized prepolymer for solid phase polymerization (CN101374883A). The resulting polymer and a heat stabilizer were melt-kneaded to achieve granulation, but an auxiliary agent such as an antioxidant, a passivating agent, a reinforcing agent and a hydrolysis inhibitor must be added to be melt-kneaded in the device. Although a low reaction temperature can be used to control thermal degradation and coloring of the resulting material, a secondary melting temperature above Tm+38° C. has an impact on the molecular weight and coloring of the resulting polyglycolic acid products (CN1827686 B).

Therefore, there remains a need for a continuous industrial production process of polyglycolic acid products having improved physical and chemistry properties with reduced impact by the thermal history of the polyglycolic acid.

### SUMMARY OF THE INVENTION

The present invention relates to an integrated production process of polyglycolic acid products and a related apparatus. The inventors have surprisingly found that such an integrated process reduces the impact of the thermal history of polyglycolic acid on the properties of polyglycolic acid products produced from the polyglycolic acid.

A process for producing a polyglycolic acid product from glycolide at 140-260° C. is provided. The process comprises (a) mixing glycolide with a catalyst and a structure regulator in a prepolymerization reactor, whereby a melted prepolymerization composition is formed; (b)polymerizing the melted prepolymerization composition in a polymerization reactor, whereby a melted polymerization composition is formed; (c) optimizing the melted polymerization composition in an optimization reactor, whereby melted polyglycolic acid is formed; and (d) molding the melted polyglycolic acid through a forming mould, whereby a polyglycolic acid product is formed. The process may further comprise molding the melted polyglycolic acid into the polyglycolic acid product in the form of granules, fibers, rods, balls, tubes, sheets, films, or underwater pellets.

A process for producing a polyglycolic acid product from glycolide at 140-260° C. is provided. The process comprises: (a) mixing glycolide with a catalyst and a structure regulator in a prepolymerization reactor, whereby a melted prepolymerization composition is formed: (b)polymerizing the melted prepolymerization composition in a polymerization reactor, whereby a melted polymerization composition is formed; and (c) molding the melted polyglycolic acid through a forming mould, whereby a polyglycolic acid product is formed.

The prepolymerization reactor may be a kettle reactor, a flat flow reactor or a tubular reactor. The catalyst may be selected from the group consisting of a rare earth element oxide, a metal magnesium compound, an alkali metal chelate compound, an organic antimony and a combination thereof. The alkali metal chelate compound may comprise tin, antimony, titanium or a combination thereof. Step (a) may be carried out at a temperature of 140-260° C. for 1 min to 5 h. The melted prepolymerization composition may have an inherent viscosity of 0.1-0.5 dl/g and/or a monomer conversion rate of 1-100%. The process may further comprise transferring the melted prepolymerization composition into the polymerization reactor.

The polymerization reactor may be a kettle reactor, a flat flow reactor or a tubular reactor. Step (b) may be carried out at a temperature of 140-260° C. for 1 min to 72 h under an absolute pressure of 10⁻⁶-0.5 MPa. The melted polymerization composition may have an inherent viscosity of 0.1-0.5 dl/g and/or a monomer conversion rate of 50-100%. The process may further comprise transferring the melted polymerization composition into the optimization reactor. The process may further comprise molding the melted polymerization mixture into the polyglycolic acid product in the form of granules, fibers, rods, balls, tubes, sheets, films, or underwater pellets.

The optimization reactor may be a kettle reactor, a flat flow reactor or a tubular reactor. Step (c) may comprise devolatilizing the melted polymerization composition. Step (c) may comprise modifying the melted polymerization composition in the presence of a modifier. Step (c) may be carried out at a temperature of 140-260° C. and a rotation speed of 1-500 rpm under an absolute pressure of 1 Pa to atmospheric pressure for 1 min to 24 h. The melted polyglycolic acid may have an inherent viscosity of 1.5-2.5 dl/g.

The forming mould may be connected with an outlet of the optimization reactor. The forming mould may be selected from the group consisting of an underwater pellet forming mould, a calendering film forming mould, a tape casting forming mould, a melted body blowing film mould, a spin forming mould, a rod extrusion mould, a tube extrusion mould, and a sheet extrusion mould.

According to the process, the final monomer conversion rate may be greater than 99%.

For each process of the invention, a polyglycolic acid product produced according to the process is provided. The polyglycolic acid product may have a molecular weight of 90,000-300,000. The polyglycolic acid product may have a yellowness index (YI) of 9-70. The polyglycolic acid product may have a mean square rotation radius of 38-53 nm.

An apparatus for producing a polyglycolic acid product from glycolide is provided. The production may be carried out at 140-260° C., 160-257° C., 180-245° C. or 200-230° C. The apparatus comprises a prepolymerization rector, a polymerization reactor, an optimization reactor and a forming mould. The glycolide, a catalyst and a structure regulator are mixed to form a melted prepolymerization composition in the prepolymerization reactor. The melted prepolymerization composition is polymerized to form a melted polymerization composition in a polymerization reactor. The melted polymerization composition is optimized to form a melted optimized polyglycolic acid in the optimization reactor. The melted optimized polyglycolic acid is molded into a polyglycolic acid product through the forming mould. Each of the prepolymerization reactor, the polymerization reactor and the optimization reactor may be a kettle reactor, a flat flow reactor or a tubular reactor. The forming mould may be selected from the group consisting of an underwater pellet forming mould, a calendering film forming mould and rollers, a cast film forming mould and take-up apparatus, a melted blown film apparatus, a spin forming mould fiber mould and spinning apparatus, a rod extrusion mould, a tube extrusion mould, and a sheet extrusion mould.

### BRIEF DESCRIPTION OF THE DRAWINGS

FIG. 1 is a diagram showing a process for producing a polyglycolic acid product according to one embodiment of the invention. Glycolide, catalyst and a structure regulator are mixed in a prepolymerization reactor (A) and react to form a melted prepolymerization composition. The melted prepolymerization composition is then transferred into a polymerization reactor (B) for polymerization reaction under nitrogen (N₂) to form a melted polymerization composition. The melted polymerization composition is subsequently transferred into an optimization reactor (C) and reacts with a modifier under vacuum to form melted polyglycolic acid. The melted polyglycolic acid is molded directly into granules, fibers, rods, balls, tubes, sheets, films, or underwater pellets. Each of the prepolymerization reactor, the polymerization reactor and the optimization reactor may be a kettle reactor, a flat flow reactor or a tubular reactor.

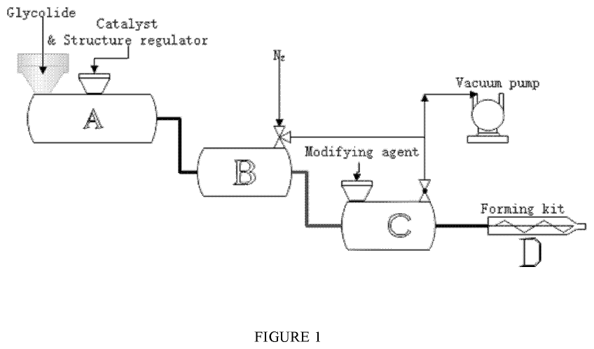

### DETAILED DESCRIPTION OF THE INVENTION

The invention provides a low-temperature continuous integrated polymerization and molding process for producing a polyglycolic acid product that maintain the desirable chemical and physical properties of polyglycolic acid. The invention is made based on the inventor's discovery that the addition of a modifier to any melted section in the integrated process in combination with the use of different moulds to meet different molding needs enables the production of the polyglycolic acid products at a temperature below a desirable temperature, which is the melting temperature of the polyglycolic acid plus 38° C. (Tm+38° C.). Also provided is a combination of multi-stage apparatus providing a polymerization system of polyglycolic acid with the characteristics of continuous production, multi-adaptability, high conversion rate and easy industrialization amplification to achieve industrial production level at, for example, kilotons. The apparatus supports a pre-mixing, polymerization, modification and molding integrated process of raw materials such as glycolide for producing polyglycolic acid products.

The invention relates to a low-temperature molding process of polyglycolic acid, which takes into account the big influence of the thermal history of polyglycolic acid and the temperature range of slice molding is narrow. Excessive thermal history causes increased yellowness index, reduced mean square rotation radius, and deteriorated mechanical properties. The present invention provides an integrated polymerization and molding process. This process reduces a remelting molding step for slicing and reduces the molding temperature to achieve a low temperature continuous system for polymerization and molding.

One objective of the present invention is to reduce the influence of a high thermal history of polyglycolic acid slices on the performance of a second modification and molding process. This may be achieved by modification of polyglycolic acid in an integrated process of polymerization, modification and molding so that the chemical and physical properties of the polyglycolic acid product are maintained.

Another objective of the present invention is to remove the thermal history of polyglycolic acid above Tm+38° C. during modification and processing. Molding and modification below Tm+38° C. of the polyglycolic acid may be achieved by adding a modifier to any melted section in the reaction process and using different mould forming moulds and standard polymer processing apparatus to meet different molding requirements.

A further objective of the present invention is to solve the problem associated with continuous industrial production of polyglycolic acid. Because indirect reaction devices may affect the heterogeneity of the quality of the polyglycolic acid materials, and existing reaction devices are combined for synergistic effects of the characteristics of different devices and thus enables continuous industrial production of polyglycolic acid products with stability and uniformity.

In the field of plastics engineering, blending modification of slices is the easiest way to functionalize and differentiate the materials. A conventional blending modification process achieves a state of complete melting by giving a thermal history above the melting point of the slice and sufficient dispersion and mixing of the modified component and the material by kneading.

In the field of functional modification of polyglycolic acid, a conventional method is applied to give polyglycolic acid solids a thermal history above Tm+38° C. As verified by Differential Scanning calorimetry (DSC), after heating polyglycolic acid in a crucible at a temperature above Tm+38 for 1 min in the absence of any additive (e.g., heat stabilizers, antioxidants, chain extenders, and passivators) in order to eliminate completely the thermal history of the polyglycolic acid, the material in the crucible turns black. Therefore, a thermal history temperature of Tm+38° C. will cause degradation of polyglycolic acid during modification or processing, affecting indicators such as the yellowness index, weight-average molecular weight and mechanical properties of the polyglycolic acid product.

In view of the narrow processing temperature range of polyglycolic acid, one or more of a kettle reactor, a tubular reactor and a flat flow reactor may be combined into a reactor system. A kettle reactor system may comprise a vertical kettle reactor and/or a horizontal self-cleaning kettle reactor. A flat flow reaction extrusion system may comprise a flat flow reaction form such as a single screw reaction extruder and a twin screw reaction extruder. A tubular reaction system may include a SK type static mixer, SV type static mixer, SX type static mixer and other static mixer forms. As a result, continuous glycolide ring-opening polymerization in a melting state, on-line modification and integrated molding processes can be accomplished.

The present inventors have found that in a continuous integrated reaction apparatus, modification and processing can be maintained in horizontal flow and in melting state simultaneously. At this time, a lot of heat is maintained as the frictional heat generated from simultaneous flowing contributes to modification and molding, and the possibility of charring is small. Thus, the polymer can be modified and processed under relatively low temperature conditions to maintain the physical and chemical properties of the material.

The term “monomer conversion rate” used herein refers to the monomers incorporated into a polymer after a polymerization reaction as a percentage of the total monomers before the polymerization reaction. The “final monomer conversion rate” may be calculated as 100 percentage subtracted by the percentage of the remaining monomer after a polymerization reaction over the total monomer before the polymerization reaction.

A process for producing a polyglycolic acid product from glycolide is provided. The process may be carried out at a temperature of about 140-260° C., 160-257° C., 180-245° C. or 200-230° C. The process comprises mixing, polymerization and molding, and optionally optimization between polymerization and molding.

In the mixing step, glycolide, a catalyst and a structure regulator may be mixed in a prepolymerization reactor to form a melted prepolymerization composition.

A kettle reactor, a flat flow reactor or a tubular reactor may be used as the prepolymerization reactor. The catalyst and the structure regulator may be added into the prepolymerization reactor by a weightless weighing or metering pump.

The catalyst is a ring-opening polymerization catalyst, and may be present in an amount of about 0.0001-5.000 wt % of the weight of the glycolide. The catalyst may be a metal or non-metal catalyst. The catalyst may be selected from the group consisting of a rare earth element oxide, a metal magnesium compound, an alkali metal chelate compound, an organic guanidine and a combination thereof. The alkali metal chelate may comprise tin, antimony, titanium or a combination thereof.

The structure regulator may be present in an amount not exceeding about 1, 2, 3, 4, 5, 6, 7, 8, 9 or 10 wt %, preferably not exceeding about 5 wt %, of the weight of the glycolide. The structure regulator may be selected from the group consisting of one or more comonomers or polymers having branched or long-chain structures such as alkyl monohydric alcohols, alkyl polyols and polyethylene glycol (PEG).

In the prepolymerization reactor, the reaction temperature may be from 83° C., the melting temperature of glycolide (Tm_{GL}), to 220° C., the melting temperature of polyglycolic acid (Tm). The lower limit of the reaction temperature may be preferably Tm_{GL}+20° C., more preferably Tm_{GL}+40° C. The upper limit of the reaction temperature may be preferably Tm−20° C., more preferably Tm−40° C. The reaction time may be from about 1 min to about 5 h, preferably from about 5 min to about 4 h, more preferably from about 10 min to about 3 h.

The melted prepolymerization composition comprises polyglycolic acid formed by monomer glycolide in the prepolymerization reactor. The monomer conversion rate may be about 30-80, 10-90 or 1-100%.

The melted prepolymerization composition may have an inherent viscosity about 0.01-1.00, 0.05-0.75 or 0.1-0.5 dl/g. The melted prepolymerization composition may be transferred from the prepolymerization reactor to the polymerization reactor by melt delivery.

In the polymerization step, the melted prepolymerization composition is polymerized in a polymerization reactor to form a melted polymerization composition.

The polymerization reactor may be selected from a kettle reactor, a flat flow reactor, and a tubular reactor. Further chain growth of the prepolymerization composition may be achieved by adjusting various polymerization conditions, for example, reaction temperature, reaction time, and system pressure. The reaction temperature may be from polyglycolic acid's crystallization temperature (Tc+10°) C., to polyglycolic acid's melting temperature (Tm)+37° C. The lower limit of the reaction temperature may be preferably Tc+20° C., more preferably Tc+40° C. The upper limit of the reaction temperature may be preferably Tm+20° C., more preferably Tm ° C. The reaction time may be from about 1 min to about 72 h, preferably from about 5 min to about 48 h, more preferably from about 10 min to about 24 h. The upper limit of the system pressure (absolute pressure) may be 0.5 MPa, preferably 0.2 MPa, more preferably 0.1 MPa. The lower limit may be about 10⁻⁶ MPa, preferably about 10⁻⁴ MPa, more preferably about 10⁻² Mpa.

The melted polymerization composition comprises polyglycolic acid. The polyglycolic acid formed in the polymerization reactor may have an inherent viscosity of about 0.1-2.0 or 0.5-1.5 dl/g. The monomer conversion rate of glycolide in the polymerization reactor may be about 40-100, 50-100 or 60-100%. The polyglycolic acid composition in the polymerization reactor may be transferred to the optimization reactor by melt transportation.

In the modification step, the melted polymerization composition may be modified by a modifier in an optimization reactor to make a melted optimized polyglycolic acid.

The optimization reactor may be a kettle reactor, a flat flow reactor or a tubular reactor. The optimization step may comprise devolatilizing the melted polymerization composition and/or modifying the melted polymerization composition in the presence of a modifier.

The modifier may be selected from the group consisting of an antioxidant, a metal deactivator, an anti-hydrolysis agent, a light stabilizer, an inorganic components, a chain extender, and a combination thereof. The antioxidant may be selected from the group consisting of BASF Irganox 168, 101, 245, 1024, 1076, 1098, 3114, MD 1024, 1025; ADEKA AO-60, 80; STAB PEP-36, 8T; Albemarle AT One or more of −10, 245, 330, 626, 702, 733, 816, 1135. The metal deactivator may be selected from the group consisting of MD24, Chel-180, XL-1, CDA10 and CDA6. The anti-hydrolysis agent may be selected from the group consisting of one or more of carbodiimides. The light stabilizer may be selected from the group consisting of BASF Chel-180, Eastman OABH, Naugard XL-1, MD24, oxalic acid derivatives such as ADEKA STAB CDA-1, 6, terpenoids, salicylic acid derivatives, benzotriazoles, terpenoids and a combination thereof. The inorganic component may be selected from the group consisting of glass fiber, carbon fiber, carbon nanotube, talc and calcium carbonate. The chain extender may be ADR4300, CESA or a combination thereof.

The optimization effects may be controlled by adjusting the temperature, rotation speed and vacuum of the reaction system in the optimization reaction. The upper limit of the reaction temperature may be 256° C., polyglycolic acid's melting temperature (Tm)+37° C., preferably Tm+20° C., more preferably Tm+10° C. The lower limit of the reaction temperature may be 160° C., polyglycolic acid's crystallization temperature (Tc)+20° C., preferably Tc+30° C., more preferably Tc+40° C. The screw rotation speed may be about 1-500 rpm. The upper limit of the rotation speed may be about 300 rpm, more preferably about 200 rpm. The lower limit may be preferably about 25 rpm, more preferably about 50 rpm. The system vacuum (absolute pressure) may range from about 1 Pa to about atmospheric pressure, preferably about 1-5,000 Pa, more preferably about 1-100 Pa. The reaction time may be from about 1 min to about 24 h, preferably from about 5 min to about 12 h, and more preferably from about 10 min to 6 h. The optimized polyglycolic acid may have an inherent viscosity of about 0.1-3, 0.5-2.5 or 1.5-2.5 dl/g.

In the molding step, the melted polyglycolic acid or the melted polymerization composition may be molded through a forming mould to form a polyglycolic acid product.

In order to solve the problems of degradation and coloration caused by polyglycolic acid's thermal history of Tm+38° C., a strip mould at the optimization reactor outlet may be replaced with a molding mould corresponding to a downstream product. The forming mould may be selected from the group consisting of an underwater pellet forming mould, a calendering film forming mould and rollers, a cast film forming mould and take-up apparatus, a melted blown film apparatus, a spin forming mould fiber mould and spinning apparatus, a rod extrusion mould, a tube extrusion mould, and a sheet extrusion mould.

The resulting polyglycolic acid product may maintain the physical and chemical properties of polyglycolic acid to the greatest extent, including yellowness index (YI), weight-average molecular weight, strength and mean square radius of rotation.

The polyglycolic acid product may have a molecular weight of about 50,000-400,000, 90,000-300,000 or 250,000-300,000. The molecular weight of the polyglycolic acid product may be no more than about 5%, 10%, 15% or 20% different from that of the polyglycolic acid used to make the polyglycolic acid.

The polyglycolic acid product may have a yellowness index (YI) of about 1-100, 2-90, 5-80 or 9-70. The yellowness index of the polyglycolic acid product may be no more than about 5%, 10%, 15% or 20% different from that of the polyglycolic acid used to make the polyglycolic acid.

The polyglycolic acid product may have a strength of about 180 MPa-90 MPa, 165 MPa-100 MPa or 155 MPa-105 MPa. The strength of the polyglycolic acid product may be no more than about 5%, 10%, 15% or 20% different from that of the polyglycolic acid used to make the polyglycolic acid.

The polyglycolic acid product may have a mean square rotation radius of about 20-70, 30-60 or 38-53 nm. The mean square rotation radius of the polyglycolic acid product may be no more than about 5%, 10%, 15% or 20% different from that of the polyglycolic acid used to make the polyglycolic acid.

An apparatus for producing a polyglycolic acid product from glycolide is provided. The production may be carried out at 140-260° C., 160-257° C., 180-245° C. or 200-230° C. The apparatus comprises a prepolymerization rector, a polymerization reactor, an optimization reactor and a forming mould. The glycolide, a catalyst and a structure regulator are mixed to form a melted prepolymerization composition in the prepolymerization reactor. The melted prepolymerization composition is polymerized to form a melted polymerization composition in a polymerization reactor. The melted polymerization composition is optimized to form a melted optimized polyglycolic acid in the optimization reactor. The melted optimized polyglycolic acid is molded into a polyglycolic acid product through the forming mould. Each of the prepolymerization reactor, the polymerization reactor and the optimization reactor may be a kettle reactor, a flat flow reactor or a tubular reactor. The forming mould may be selected from the group consisting of an underwater pellet forming mould, a calendering film forming mould and rollers, a cast film forming mould and take-up apparatus, a melted blown film apparatus, a spin forming mould fiber mould and spinning apparatus, a rod extrusion mould, a tube extrusion mould, and a sheet extrusion mould.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

### Example 1. Polyglycolic Acid Products

Polyglycolic acid products 1-28 and comparative products 1-4 were prepared and their physical and chemical properties were tested.

Polyglycolic acid product 1 was prepared from glycolide. The glycolide, dihydrate tin dichloride (ring-opening polymerization catalyst) in amount of 0.5 part relative to the weight of the glycolide, and lauryl alcohol (structural regulator) in an amount of 0 part relative to the weight of the glycolide, were mixed uniformly in a prepolymerization kettle at 120° C. for 60 min. The material of the prepolymerization reactor was transferred into a polymerization reactor, and reacted at 200° C. for 300 min under an absolute pressure of 0.1 MPa. The polymerization reactor was a flat flow reactor, which could be a static mixer, twin-screw unit or horizontal disc reactor. The material in the polymerization reactor was transferred into an optimization reactor at 220° C., a mixing speed of 200 RPM, an absolute pressure of 50 Pa for 30 min. The resulting mixture was granulated. The reaction conditions are summarized in Table 1.

Polyglycolic acid products 2-25 were prepared using the same method as that for polyglycolic acid product 1 except the reaction conditions as set forth in Table 1.

Comparative product 1(C1) was prepared from glycolide. The glycolide, dihydrate tin dichloride (ring-opening polymerization catalyst) in an amount of 0.05 part relative to the weight of the glycolide and lauryl alcohol (structural regulator) in an amount of 0.05 part by weight relative to the weight of the glycolide, were mixed in a polymerization reactor for polymerization at 200° C. for 180 min under an absolute pressure of 0.1 MPa. After polymerization, the resulting pellet was cooled and pulverized. Additional polymerization was carried out at 160° C. for 720 min. The results are shown in Table 1. The reaction conditions are summarized in Table 1.

Polyglycolic acid product 5 and Comparative product 1 (C1) was each cooled and granulated through the mould at the outlet of the optimization reactor to form slices.

Polyglycolic acid products 26-28 were prepared in the same way as that for polyglycolic acid product 5 except that the final granulation mould was changed to a film forming assembly, a fiber-forming assembly or a rod assembly so that the resulting polyglycolic acid was extruded into a polyglycolic acid product in the form of films, fibers or rods. The reaction conditions are summarized in Table 2.

Comparative products 2-4(C2-4) were prepared in the same way as that for comparative product 1 except that the resulting polyglycolic acid was added to a film forming machine, a spinning machine or a single-screw rod forming machine, respectively, and given a heat history higher than Tm+38° C. to achieve complete melted in the forming machine to form polyglycolic acid products 2-4 in the form of films fibers or rods. The reaction conditions are summarized in Table 2.

The polyglycolic acid products 1-28 and comparative products 1-4 were evaluated in the following tests and the results are shown in Tables 1 and 2.

A. Weight-Average Molecular Weight and its Distribution

A sample is dissolved in a solution of 5 mmol/L sodium trifluoroacetate in hexafluoroisopropanol to prepare a solution of 0.05-0.3 wt % (mass fraction). The solution is then filtered with a 0.4 μm pore size polytetrafluoroethylene filter. 20 μL of the filtered solution is added to the Gel permeation chromatography (GPC) injector for determination of molecular weight of the sample. Five standard molecular weights of methyl methacrylate with different molecular weights are used for molecular weight correction.

B. Yellowness Index (YI) Value

A product with smooth surface and no obvious convexity was selected, and the yellowness value (YI) of the product was determined by using NS series color measuring instrument of Shenzhen 3nh Technology Company, Ltd, Nanshan District, China. According to ASTM E313, the measurement was carried out three times under the conditions of 10 degree observation angle, D65 observation light source from the same company and reflected light measurement, and the average value was calculated to determine the yellowness value (YI) of the product.

C. Strength Test

According to the requirements of GBT-1040-2006, the slice/pellet, film and rod products were processed into standard test strips such as 1B, 2, 4 and 5. The tensile test method for the fiber product is carried out according to the requirements of GBT-14337-2008. The test was carried out using an Instron 3366 universal testing machine, and the remaining test conditions were performed in accordance with ISO standards. For the rods of Sample 28 and Comparative Sample 4, the temperature of the tensile strength test was changed to 150° C., with a view to paying attention to the properties of the material at high temperatures.

D. Monomer Conversion Rate

The monomer conversion of a sample was tested by gravimetric analysis. Approximately 0.5 g of the sample was placed in a closed container, 15 ml of hexafluoroisopropanol was precisely added. The mixture was screwed and dissolved in a water bath at 60° C. for 3-4 hours. After dissolution is completed, a sample solution was transferred into a 100 ml round bottom (flat bottom) flask. 10 ml of acetone was precisely added. The polymer was precipitated by shaking to obtain a solid product. The precipitate was filtered. The solid product was placed in a vacuum drying oven at 40° C. After drying for 48 hours, the mass of the solid matter was weighed and recorded as W1. The monomer conversion rate was W1/0.5.

E. Mean Square Radius of Gyration

A mean square radius of gyration was determined by using a laser light scattering instrument (helium/neon laser generator power: 22 mW) of the German ALV company CGS-5022F type to measure the mean square radius of gyration of the polymer. A polymer sample was dried to a constant weight in a vacuum oven at 50° C. Hexafluoroisopropanol (HPLC grade) was used as a solvent at 25° C. to prepare a polymer having a concentration of C₀=0.001 g/g polymer/hexafluoroisopropanol solution. Four concentrations C₀, ¾C₀, ½ C₀ and ¼C₀ of the polymer/hexafluoroisopropanol solution were prepared by dilution and filtering through a 0.2 μm filter. The test wavelength was 632.8 nm; the scattering angle range was 15-150 degrees; and the test temperature was 25±0.1° C.

F. Inherent Viscosity

A sample of about 0.125 g was weighed, dissolved in 25 ml of hexafluoroisopropanol, and subjected to a constant temperature water bath at 25° C. The inherent viscosity (q) was measured using an Ubbelohde viscometer. The average was measured three times. The outflow time of each measurement did not differ by more than 0.2 s.

Although the invention is illustrated and described herein with reference to specific embodiments, the invention is not intended to be limited to the details shown. Rather, various modifications may be made in the details within the scope and range of equivalents of the claims without departing from the invention.

TABLE 1
Polyglycolic acid granules

| | | | | | | Monomer | | | | |
|---|---|---|---|---|---|---|---|---|---|---|
| | | | | | | Conversion | η1/ | | | |
| | | | Structure | Tr1 | tr1/ | Rate | (dl/ | Tr2/ | tr2/ | PaA1/ |
| No. | Glycolide | Catalyst | Regulator | ° C. | min | 1/% | g) | ° C. | min | MPa |
| C1 | 1 | 5*10⁻⁵ | 5*10⁻⁵ | | | | | 200 | 180 | 0.1 |
| 1 | 1 | 0.05 | 0 | 120 | 60 | 50 | 0.3 | 200 | 300 | 0.1 |
| 2 | 1 | 10⁻³ | 0 | 120 | 60 | 45 | 0.25 | 200 | 300 | 0.1 |
| 3 | 1 | 5*10⁻⁵ | 0 | 120 | 60 | 43 | 0.2 | 200 | 300 | 0.1 |
| 4 | 1 | 10⁻⁶ | 0 | 120 | 60 | 35 | 0.1 | 200 | 300 | 0.1 |
| 5 | 1 | 5*10⁻⁵ | 5*10⁻⁵ | 120 | 60 | 75 | 0.5 | 200 | 300 | 0.1 |
| 6 | 1 | 5*10⁻⁵ | 0.005 | 120 | 60 | 70 | 0.47 | 200 | 300 | 0.1 |
| 7 | 1 | 5*10⁻⁵ | 0.05 | 120 | 60 | 65 | 0.45 | 200 | 300 | 0.1 |
| 8 | 1 | 5*10⁻⁵ | 5*10⁻⁵ | 85 | 60 | 55 | 0.35 | 200 | 300 | 0.1 |
| 9 | 1 | 5*10⁻⁵ | 5*10⁻⁵ | 160 | 60 | 70 | 0.48 | 200 | 300 | 0.1 |
| 10 | 1 | 5*10⁻⁵ | 5*10⁻⁵ | 120 | 1 | 30 | 0.12 | 200 | 300 | 0.1 |
| 11 | 1 | 5*10⁻⁵ | 5*10⁻⁵ | 120 | 300 | 80 | 0.5 | 200 | 300 | 0.1 |
| 12 | 1 | 5*10⁻⁵ | 5*10⁻⁵ | 120 | 60 | 75 | 0.5 | 160 | 300 | 0.1 |
| 13 | 1 | 5*10⁻⁵ | 5*10⁻⁵ | 120 | 60 | 75 | 0.5 | 257 | 300 | 0.1 |
| 14 | 1 | 5*10⁻⁵ | 5*10⁻⁵ | 120 | 60 | 75 | 0.5 | 200 | 1 | 0.1 |
| 15 | 1 | 5*10⁻⁵ | 5*10⁻⁵ | 120 | 60 | 75 | 0.5 | 200 | 4320 | 0.1 |
| 16 | 1 | 5*10⁻⁵ | 5*10⁻⁵ | 120 | 60 | 75 | 0.5 | 200 | 300 | 0.5 |
| 17 | 1 | 5*10⁻⁵ | 5*10⁻⁵ | 120 | 60 | 75 | 0.5 | 200 | 300 | 10⁻⁶ |
| 18 | 1 | 5*10⁻⁵ | 5*10⁻⁵ | 120 | 60 | 75 | 0.5 | 200 | 300 | 0.1 |
| 19 | 1 | 5*10⁻⁵ | 5*10⁻⁵ | 120 | 60 | 75 | 0.5 | 200 | 300 | 0.1 |
| 20 | 1 | 5*10⁻⁵ | 5*10⁻⁵ | 120 | 60 | 75 | 0.5 | 200 | 300 | 0.1 |
| 21 | 1 | 5*10⁻⁵ | 5*10⁻⁵ | 120 | 60 | 75 | 0.5 | 200 | 300 | 0.1 |
| 22 | 1 | 5*10⁻⁵ | 5*10⁻⁵ | 120 | 60 | 75 | 0.5 | 200 | 300 | 0.1 |
| 23 | 1 | 5*10⁻⁵ | 5*10⁻⁵ | 120 | 60 | 75 | 0.5 | 200 | 300 | 0.1 |
| 24 | 1 | 5*10⁻⁵ | 5*10⁻⁵ | 120 | 60 | 75 | 0.5 | 200 | 300 | 0.1 |
| 25 | 1 | 5*10⁻⁵ | 5*10⁻⁵ | 120 | 60 | 75 | 0.5 | 200 | 300 | 0.1 |

| | Monomer | | | | | | | | | |
|---|---|---|---|---|---|---|---|---|---|---|
| | Conversion | η2/ | | | | | η3/ | | | |
| | Rate | (dl/ | Tr3/ | tr3/ | | PaA2/ | (dl/ | | | Rg/ |
| No. | 2/% | g) | ° C. | min | RPM | Pa | g) | Mw | YI | mm |
| C1 | | | 160 | 720 | | | | 238000 | 16 | 50.2 |
| 1 | 75 | 0.58 | 220 | 30 | 200 | 50 | 0.8 | 119256 | 26 | 41.3 |
| 2 | 70 | 0.55 | 220 | 30 | 200 | 50 | 0.7 | 96377 | 33 | 38.5 |
| 3 | 67 | 0.53 | 220 | 30 | 200 | 50 | 0.67 | 105116 | 28 | 39.8 |
| 4 | 65 | 0.5 | 220 | 30 | 200 | 50 | 0.6 | 90400 | 24 | 38 |
| 5 | 98.5 | 1.5 | 220 | 30 | 200 | 50 | 2.2 | 294000 | 9 | 53 |
| 6 | 96 | 1.34 | 220 | 30 | 200 | 50 | 1.79 | 286913 | 11 | 52.3 |
| 7 | 90 | 1 | 220 | 30 | 200 | 50 | 1.2 | 157837 | 30 | 47 |
| 8 | 78 | 0.6 | 220 | 30 | 200 | 50 | 0.8 | 116904 | 26 | 39 |
| 9 | 86 | 0.76 | 220 | 30 | 200 | 50 | 1 | 159873 | 20.5 | 47.4 |
| 10 | 60 | 0.5 | 220 | 30 | 200 | 50 | 0.65 | 99870 | 8 | 38.7 |
| 11 | 95 | 1.4 | 220 | 30 | 200 | 50 | 1.48 | 184955 | 60 | 48.3 |
| 12 | 88 | 0.8 | 220 | 30 | 200 | 50 | 1 | 166575 | 21 | 47.6 |
| 13 | 92 | 1.38 | 220 | 30 | 200 | 50 | 1.5 | 195939 | 18 | 49.1 |
| 14 | 80 | 0.68 | 220 | 30 | 200 | 50 | 0.9 | 148667 | 22 | 46.9 |
| 15 | 99 | 1.5 | 220 | 30 | 200 | 50 | 1.7 | 276572 | 70 | 52 |
| 16 | 98 | 1.48 | 220 | 30 | 200 | 50 | 1.61 | 247000 | 11.5 | 50.8 |
| 17 | 99.2 | 1.5 | 220 | 30 | 200 | 50 | 1.68 | 263000 | 15 | 51.7 |
| 18 | 98.5 | 1.5 | 170 | 30 | 200 | 50 | 1.65 | 254606 | 12.3 | 51 |
| 19 | 98.5 | 1.5 | 257 | 30 | 200 | 50 | 1.35 | 169832 | 24 | 47.8 |
| 20 | 98.5 | 1.5 | 220 | 1 | 200 | 50 | 1.6 | 245119 | 14.3 | 50.3 |
| 21 | 98.5 | 1.5 | 220 | 1440 | 200 | 50 | 1.55 | 190579 | 68 | 48.5 |
| 22 | 98.5 | 1.5 | 220 | 30 | 1 | 50 | 1.58 | 192180 | 20 | 48.6 |
| 23 | 98.5 | 1.5 | 220 | 30 | 500 | 50 | 1.47 | 169800 | 66.5 | 47.8 |
| 24 | 98.5 | 1.5 | 220 | 30 | 200 | 0.1*10⁶ | 1.53 | 200000 | 15.5 | 49.6 |
| 25 | 98.5 | 1.5 | 220 | 30 | 200 | 1 | 1.91 | 289000 | 13 | 52.9 |

Note:
Tr1, tr1, η1 represent reaction the temperature, reaction time, and product viscosity of the pre-preparation reaction stage (A), respectively; Tr2, tr2, η2, PaA1 represents the reaction temperature, reaction time, product viscosity and pressure in the polymerization stage (B); Tr3, tr3, η3, PaA2 represent the reaction temperature, reaction time, product viscosity and pressure of the optimization reaction stage (C). Rg is the mean square radius of gyration of the polyglycolic acid product.

TABLE 2
Polyglycolic acid slices, films, fibers and rods

| No. | Product | Mw0 | Mw1 | ΔMw/% | YI0 | YI1 | ΔYI/% | Strength | |
|---|---|---|---|---|---|---|---|---|---|
| 5 | pellet | 294000 | 280000 | 4.8 | 9 | 11.7 | 14.4 | 130 | MPa |
| C1 | pellet | 238000 | 190400 | 20 | 16 | | | 117 | MPa |
| 26 | Film | 294000 | 265000 | 9.9 | 9 | 13.4 | 48.9 | 115 | MPa |
| C2 | Film | 600000 | | | | | | 76.1 | MPa |
| 27 | Fiber | 294000 | 270000 | 8.2 | 9 | 10.2 | 13.3 | 18.2 | cN/dtex |
| C3 | Fiber | 600000 | | | | | | 12.4 | cN/dtex |

| | | | | | | | | |
|---|---|---|---|---|---|---|---|---|
| 28 | Rod | 294000 | 273000 | 7.1 | 9 | 9.8 | 8.9 | 60 MPa |
| | | | | | | | | (150° C.) |
| C4 | Rod | 230000 | | | | | | 45 MPa |
| | | | | | | | | (50° C.) |

Note:
Mw0 represents the molecular weight of the product passing through the A, B, and C reaction stages. Mw1 represents the molecular weight of the product after the product has undergone the molding process. YI0 represents the yellowness of the product after the reaction stages of A, B, and C. YI1 represents the yellowness of the product after the product undergoes the molding process.

1. A process for producing a polyglycolic acid product from glycolide at 140-260° C., comprising:
(a) mixing glycolide with a catalyst and a structure regulator in a prepolymerization reactor, whereby a melted prepolymerization composition is formed;
(b) polymerizing the melted prepolymerization composition in a polymerization reactor, whereby a melted polymerization composition is formed;
(c) optimizing the melted polymerization composition in an optimization reactor, whereby melted polyglycolic acid is formed; and
(d) molding the melted polyglycolic acid through a forming mould, whereby a polyglycolic acid product is formed.

2. A process for producing a polyglycolic acid product from glycolide at 140-260° C., comprising:
(a) mixing glycolide with a catalyst and a structure regulator in a prepolymerization reactor, whereby a melted prepolymerization composition is formed;
(b) polymerizing the melted prepolymerization composition in a polymerization reactor, whereby a melted polymerization composition is formed;
(c) molding the melted polyglycolic acid through a forming mould, whereby a polyglycolic acid product is formed.

3. The process of claim 1, wherein the prepolymerization reactor is a kettle reactor, a flat flow reactor or a tubular reactor.

4. The process of claim 1, wherein the catalyst is selected from the group consisting of one or more of metal or non-metal catalysts such as a rare earth element oxide, a metal magnesium compound, an alkali metal chelate compound, an organic guanidines.

5. The process of claim 4, wherein the alkali metal chelate compound comprises tin, antimony, titanium or a combination thereof.

6. The process of claim 1, wherein step (a) is carried out at a temperature of 140-260° C. for 1 min to 5 h.

7. The process of claim 1, wherein the melted prepolymerization composition has an inherent viscosity of 0.1-0.5 dl/g and a monomer conversion rate of 1-100%.

8. The process of claim 1, further comprising transferring the melted prepolymerization composition into the polymerization reactor.

9. The process of claim 1, wherein the polymerization reactor is a kettle reactor, a flat flow reactor or a tubular reactor.

10. The process of claim 1, wherein step (b) is carried out at a temperature of 140-260° C. for 1 min to 72 h under an absolute pressure of 10⁻⁶-0.5 MPa.

11. The process of claim 1, wherein the melted polymerization composition has an inherent viscosity of 0.1-0.5 dl/g and a monomer conversion rate of 50-100%.

12. The process of claim 1, further comprising transferring the melted polymerization composition into the optimization reactor.

13. The process of claim 1, wherein the optimization reactor is a kettle reactor, a flat flow reactor or a tubular reactor.

14. The process of claim 1, wherein step (c) comprises devolatilizing the melted polymerization composition.

15. The process of claim 1, wherein step (c) comprises modifying the melted polymerization composition in the presence of a modifier.

16. The process of claim 1, wherein step (c) is carried out at a temperature of 140-260° C. and a rotation speed of 1-500 rpm under an absolute pressure of 1 Pa to atmospheric pressure for 1 min to 24 h.

17. The process of claim 1, wherein the melted polyglycolic acid has an inherent viscosity of 1.5-2.5 dl/g.

18. The process of claim 1, wherein the forming mould is connected with an outlet of the optimization reactor, wherein the forming mould is selected from the group consisting of an underwater pellet forming mould, a calendering film forming mould and rollers, a cast film forming mould and take-up apparatus, a melted blown film apparatus, a spin forming mould fiber mould and spinning apparatus, a rod extrusion mould, a tube extrusion mould, and a sheet extrusion mould.

19. The process of claim 1, further comprising molding the melted polyglycolic acid into the polyglycolic acid product in the form of granules, fibers, rods, balls, tubes, sheets, films, or pellets.

20. The process of claim 2, further comprising molding the melted polymerization mixture into the polyglycolic acid product in the form of granules, fibers, rods, balls, tubes, sheets, films, or pellets.

21. The process of claim 1, wherein the final monomer conversion rate is greater than 99%.

22. A polyglycolic acid product produced according to the process of claim 1.

23. The polyglycolic acid product of claim 22, wherein the polyglycolic acid product has a weight average molecular weight of 90,000-300,000.

24. The polyglycolic acid product of claim 22, wherein the polyglycolic acid product has a yellowness index (YI) of 9-70.

25. The polyglycolic acid product of claim 22, wherein the polyglycolic acid product has a mean square rotation radius of 38-53 nm.

26. An apparatus for producing a polyglycolic acid product from glycolide at 140-260° C., comprising:
(a) a prepolymerization reactor in which glycolide, a catalyst and a structure regulator are mixed to form a melted prepolymerization composition;
(b) a polymerization reactor in which the melted prepolymerization composition is polymerized form a melted polymerization composition;
(c) an optimization reactor which the melted polymerization composition is optimized to form melted optimized polyglycolic acid;
(d) a forming mould through which the melted optimized polyglycolic acid is molded into a polyglycolic acid product.

27. The apparatus of claim 26, wherein each of the prepolymerization reactor, the polymerization reactor and the optimization reactor is a kettle reactor, a flat flow reactor or a tubular reactor.

28. The apparatus of claim 26, where in the forming mould is selected from the group consisting of an underwater pellet forming mould, a calendering film forming mould and rollers, a cast film forming mould and take-up apparatus, a melted blown film apparatus, a spin forming mould fiber mould and spinning apparatus, a rod extrusion mould, a tube extrusion mould, and a sheet extrusion mould.
